(19) United States
(12) Patent Application Publication
(10) Pub. No.: US 2003/0102179 A1
(43) Pub. Date: Jun. 5, 2003

(54) Hydraulic drive system with constant pressure in pressure conduit

(76) Inventor: Peter Augustinus Johannes Achten, Eindhoven (NL)

Correspondence Address: Jeffrey D. Shewchuk, THE KINNEY & LANGE BUILDING, 312 South Third Street, Minneapolis, MN, 55415-1002, US

(21) Appl. No.: 10/272,046

(22) Filed: Oct. 16, 2002

Related U.S. Application Data
(63) Continuation of application No. 09/423,341, filed on Feb. 23, 2000, now abandoned.
Application No. 09/423,341 is a 371 of international application No. PCT/NL98/00305, filed on May 27, 1998.

(30) Foreign Application Priority Data
May 28, 1997 (NL) 1,006,143

(51) Int. Cl. B60K 17/356

(52) U.S. Cl. 180/306

(57) ABSTRACT

The invention relates to a hydraulic drive system for driving hydromotors. The hydromotors may be loaded with variable loads and are coupled via hydraulic transformers with the pressure conduit which is substantially maintained at a constant pressure by means of a pump. The pump is provided with switch means by which the delivery of the pump can be alternately activated and inactivated, allowing of the pump's delivery to be varied quickly.

The invention relates to a hydraulic drive system in accordance with the preamble of claim 1.

Such a drive system is known from WO93/10345. The disadvantage with the known drive system is that the pressure in the pressure conduit is the same for all users, which means that said pressure must always be greater or equal to the maximum pressure used by any one of the users. The oil flow to the other users will then have to be reduced, resulting in loss. Another disadvantage is that. if the pressure required by a user increases due to a change of load, it may be necessary to raise the pressure in the pressure conduit, for which the pump requires some time. This prolongs the response time of the hydraulic drive system on load changes, which is disadvantageous.

It is the object of the invention to eliminate the above disadvantages and to this end the hydraulic drive system is embodied in accordance with the characterizing part of claim 1. By maintaining a constant level of pressure in the pressure conduit, which level may be higher than the pressure maximally required by a user, and by reducing said high pressure to the user pressure by means of a hydraulic transformer which involves little loss, a low-loss and fast reacting hydraulic drive system is provided.

Hydraulic drive system with hydraulic transformers which are fed from a constant pressure supply system are known as such. For feeding the constant pressure supply system, the known hydraulic drive systems use adjustable pumps which, in order to realize the necessary dynamic performance, are necessarily of a very heavy design, which is a disadvantage. In addition, for the dynamic adjustment of the delivery of such pumps a fast reacting control system is required which uses much energy. Consequently, the possibility of saving energy is largely lost.

In accordance with an embodiment of the invention the pump is executed in accordance with the characterizing part of claim 2. This provides a simple manner of obtaining a mobile drive.

Another embodiment of the invention is executed in accordance with the characterizing part of claim 3. This provides a simple manner of realizing a hydraulic drive system quickly able to react to changing demand and consequently to changes in power use, while for instance the motor, can keep turning at more or less constant or slowly altering revolutions.

Another embodiment of the invention is executed in accordance with claim 4. In such an embodiment, for instance, a direct-current motor is used which can change gear quickly and quickly reaches full revolutions, thereby allowing quick reaction to changes regarding the load of the drive system.

Another improvement is executed in accordance with claim 5. This provides a simple manner for reconverting the energy brought into the pressure conduit by the hydraulic transformers into electrical energy, so that said energy is not lost.

In accordance with an improvement of the invention the hydraulic drive system is executed in accordance with claim 6. This prevents that during operating the decrease of liquid from the pressure conduit exceeds the amount of liquid maximally supplied by the pump, which would cause too great a pressure drop in the pressure conduit, which is undesirable.

In accordance with a further improvement the power regulator is provided with means for selectively allocating power to certain users. This achieves that certain users in a drive system always have sufficient power at their disposal. This benefits the working of the apparatus or its safety.

In accordance with a further improvement, if more than one pump is involved, each pump is provided with a pressure accumulator possessing the necessary volume to limit the increase of pressure.

A further improvement of the hydraulic drive system is executed in accordance with claim 9. Hereby pressure fluctuations over the length of the pressure conduit resulting from the pulsating oil supply are avoided, and the pulsating oil flow caused by the pump(s) mainly becomes a pulsating oil flow to the first pressure accumulator, and oil flow through the pressure conduit is more even. This avoids flow losses in the pressure conduit.

The invention will now be explained with reference to a few exemplary embodiments which will be discussed with the aid of a drawing, in which

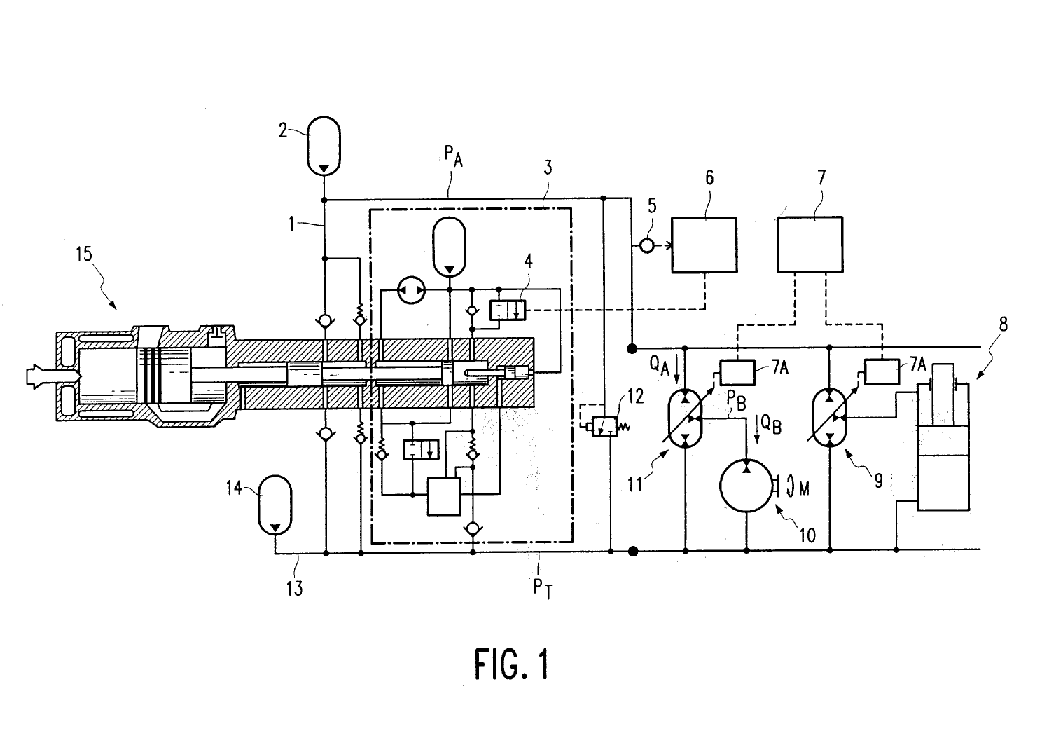

FIG. 1 shows a schematic diagram of a first embodiment of a hydraulic drive system with hydromotors having hydraulic transformers fed from a pressure conduit with a constant pressure, in which the pump is a free-piston aggregate,

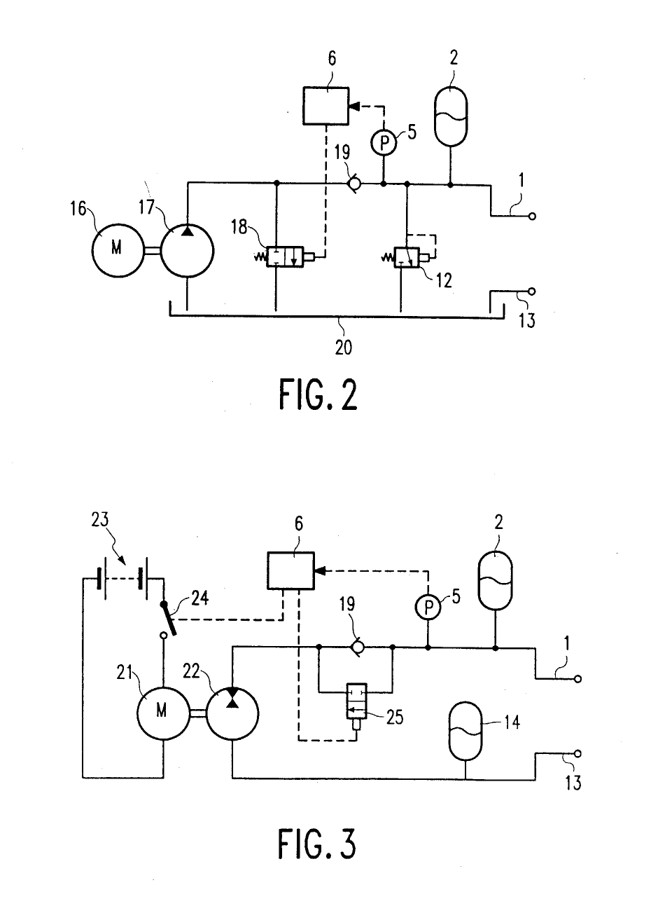

FIG. 2 shows a schematic diagram of a second embodiment of a hydraulic drive system in accordance with FIG. 1, in which the pump is a rotating pump driven by a motor,

FIG. 3 is a schematic diagram of a third embodiment of a hydraulic drive system in accordance with FIG. 1, in which the pump is a rotating pump driven by a direct-current motor fed from a battery while also being capable of returning energy to the battery,

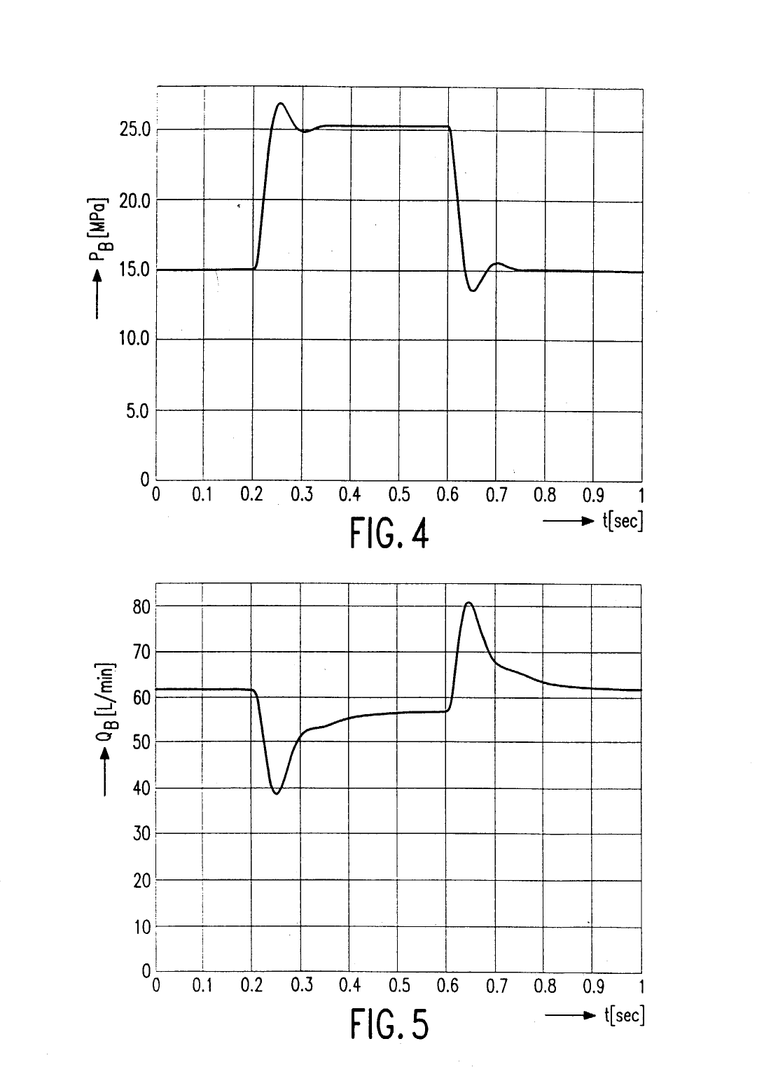

FIG. 4 is a diagram showing the pressure curve at the connection of a hydromotor shown in FIG. 1, while said hydromotor undergoes an incremental loading of +65%,

FIG. 5 is a diagram showing the curve of the volume flow through the hydromotor shown in FIG. 1, during the incremental loading of +65%,

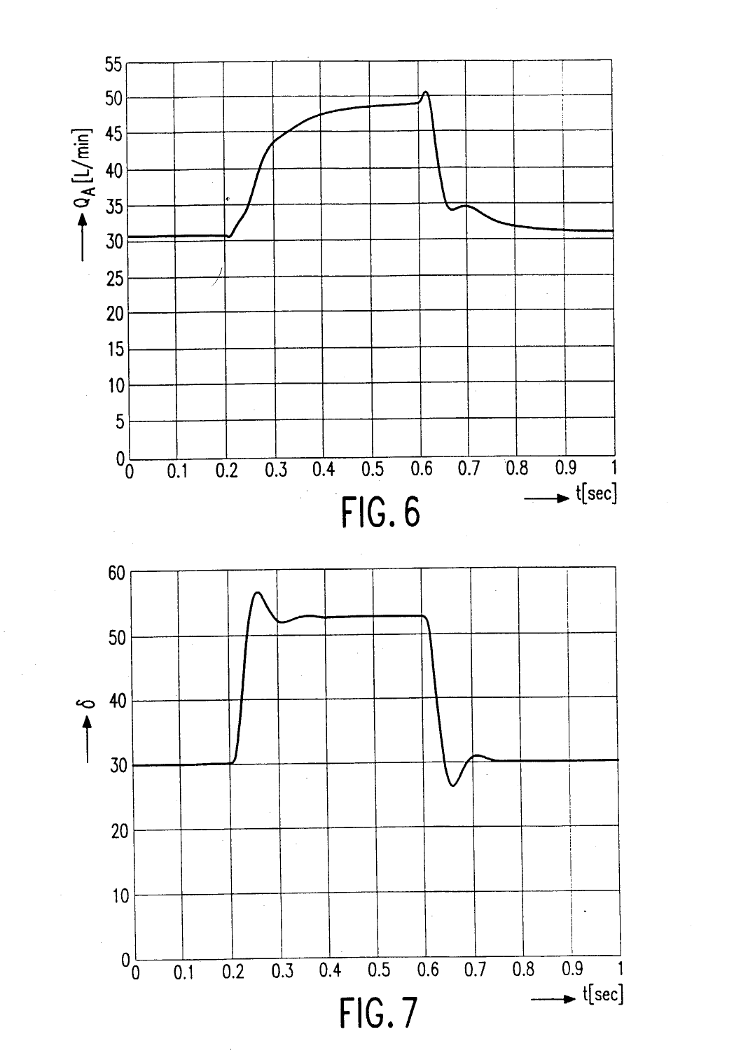

FIG. 6 is a diagram showing the curve of the volume flow to the hydraulic transformer which is coupled to the hydromotor shown in FIG. 1, during the incremental loading of +65%,

FIG. 7 is a diagram showing the curve of the adjusting signal to the hydraulic transformer which is coupled with the hydromotor shown in FIG. 1 during the incremental loading of +65%, and

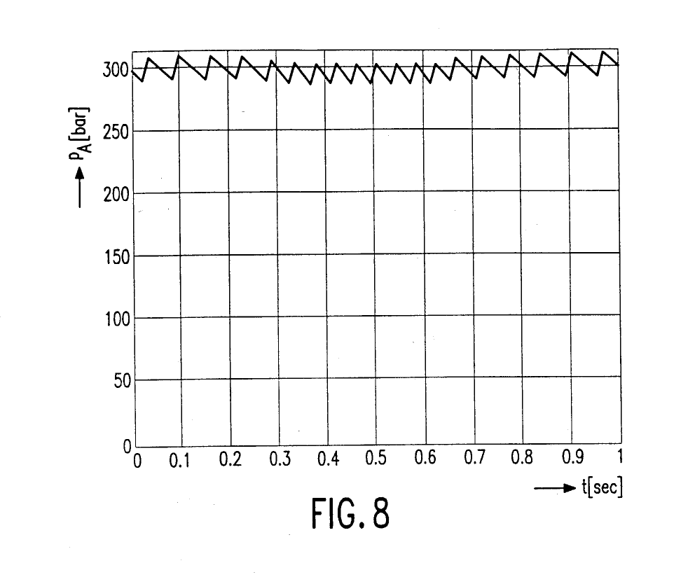

FIG. 8 is a diagram showing the curve of the pressure in the accumulator which is fed by a free-piston motor in accordance with FIG. 1 during the incremental loading represented in FIGS. 4-7.

The diagrams are a schematic representation of the various parts, while the known, and in hydraulic systems customary constructions such as safety devices for motors and the like, are not shown. Where possible, similar parts in the various figures have been provided with the same reference numbers.

FIG. 1 shows a high-pressure conduit 1 with a high-pressure accumulator 2 and a pressure pA and a low-pressure conduit 13 with a low-pressure accumulator 14 and a pressure pT. A hydraulic transformer 11 which is provided with a transformer control 7A is fed from the high-pressure conduit 1. A rotating hydromotor 10 having a regular stroke is fed from the hydraulic transformer 11 and is loaded with a torque M. Through the hydromotor 10 there is an oil flow at a pressure pB and an oil flow QB from the hydraulic transformer, the pressure pB depending, among other things, on the torque M and on the adjustment of the hydraulic transformer 11. The hydraulic transformer 11 is provided with transformer control 7A, which ensures that the transformer 11 is adjusted such that the motor assumes as much as possible the determined number of revolutions, which means that QB is as constant as possible, while the change of load is compensated by the torque M by means of adjusting the hydraulic transformer 11.

A hydraulic transformer 9 interacting with a linear motor 8 is also fed from the high-pressure conduit 1, while in addition other, not shown users, may be placed between the high-pressure conduit 1 and the low-pressure conduit 13.

The high-pressure conduit 1 is fed with compressed oil by a free-piston aggregate 15 which is known, for instance, from WO 93/10345, the content of which is to be considered included herein. A free piston mounted in the aggregate 15 is moved under the influence of a hydraulic drive system 3 and as soon as pA comes below the set value of, for instance 30 MPa, the movement of the free piston commences by means of a starting valve 4 . After 22 msec, the time required for the ignition of the air/fuel mixture in the motor, oil is supplied to the pressure conduit 1 for 11 msec. The amount of oil supplied to the pressure conduit 1 is 0.033 l, which at a maximum stroke frequency of 30 Hz and a high-pressure pA of 30 MPa produces a power of 30 kW. The high-pressure accumulator 2 has a volume of 0.7 l and a residual volume of 0.1 l, thus 0.6 l is available as gas volume for cushioning the pulsations resulting from the pulsating oil supply. This volume suffices to limit the pressure changes during oil supply and lack of discharge to approximately 1 MPa, which is considered allowable.

The high-pressure conduit 1 is equipped with a pressure gauge 5 which is connected with a pump control 6. If the pressure in the high-pressure conduit 1 drops below the adjusted value, the pump control 6 activates the free-piston aggregate 15 which will then supply oil until the pressure has regained the required level. If the demand for oil is smaller than the capacity of the free-piston aggregate 15, it will after each stroke stand still before making the next stroke. When the pressure has dropped below the adjusted value, the starting valve 4 will receive a signal from the pump control 6, in order for the next stroke to be made. Although this is not shown in FIG. 1, it is also conceivable to parallel-connect several free-piston aggregates, which are all controlled by the pump control 6.

The transformer controls 7A are connected with a maximum-power control 7. Said maximum-power control 7 ensures that the combined power taken up by the transformers does not exceed the capacity of the available pumps, for instance pump 15. This also takes into account the power returned by a transformer to the high-pressure conduit 1.

An example of an application of this control in a fork-lift truck having a riding drive and a lift drive, is that the capacity to ride or lift is limited when a load is being lifted, but that the capacity becoming available when the load is being lowered, can be made accessible to the riding drive. If power is returned by a hydraulic transformer to the high-pressure conduit 1 while there is no power demand, the pressure will rise above the adjusted value and a pressure-relief device 12 will open, and by throttling the energy it is converted into heat and is lost.

It is possible to equip the hydraulic drive system with large pressure accumulators, such as for instance, a pressure accumulator 26 which may have a capacity of, for instance, 7 litres, affording the ability to recover much energy. A pulsating oil supply from the pump 15 would result in a pulsating oil flow with a relatively high flow rate to the pressure accumulator 26. To prevent this, the gas sides of the pressure accumulators 2 and 26 are in communication by means of a gas pipe 27, so that approximately the same pressure prevails in the entire pressure conduit 1. As a consequence the pulsating flow of oil only flows to the pressure accumulator 2 located near the pump 15, and from there it flows evenly via the pressure conduit 1 to the users. In this manner high flow rates in pipes are avoided and the ensuing losses are limited.

It is also possible to adjust the overpressure-relief device 12 to 10 MPa above the minimal pressure of 30 MPa, allowing much energy to be stored. The transformer control 7A and the maximum power control 7 also receive the pressure information from the pressure gauge 5 and accordingly adapt the regulation of the hydraulic transformers 9 and 11 to the higher pressures.

FIG. 2 shows a pump with a constant stroke volume, driven by a motor 16. The motor 16 may be a combustion motor whose revolutions can be varied only relatively slowly or, for instance, a three-phase motor having a constant number of revolutions. The torque to be produced by these known motors can vary very quickly. The delivery side and the suction side of the pump 17 can be short circuited by means of a short-circuiting valve 18 and the delivery side is in communication with the high-pressure conduit 1 via a non-return valve 19. In this Figure a schematic representation of a return tank 20 is shown instead of the low-pressure conduit. Closure of the short-circuit valve 18 will cause the oil pumped by the pump 17 to flow to the high-pressure conduit 1, with the pump 17 pumping against the pressure pA. Once the high pressure pA has reached the required value, the pump control 6 activates the short-circuit valve 18 to open and the pump 17 pumps virtually without pressure, with the motor 16 hardly supplying any power any more.

FIG. 3 shows a pump 22 with constant stroke volume, which can also function as motor. The pump 22 is coupled with a direct-current motor 21, which can also function as generator. The motor 21 is fed from electrical battery 23 via a switch 24. The fact that the motor 21 is fed from the electrical battery 23 makes this drive system especially suitable for a mobile application, for instance, a fork-lift truck. The moment the measurement of the pressure gauge 5 indicates that the pressure in the pressure conduit is lower than the setting, the motor 21 is activated and the oil is pumped via the non-return valve 19 to the high-pressure conduit 1. While this takes place the valve 25 is closed. When energy is recovered, for instance when a mobile device is braking, the pressure may exceed the adjusted value. The pump control 6 then activates the valve 25 to open, after which the pump 22 commences to work as motor and the motor 21 commences to work as generator. The valve 25 shown is operated from the pump control 6, however, an embodiment it is also possible in which the valve 25 is operated hydraulically and opens when the pressure in the high-pressure conduit 1 rises above a value to be adjusted. The generated electrical current is returned to the electrical battery 23, but the manner in which this takes place is not explained.

The embodiments described above demonstrate different possibilities, and it is also quite conceivable that embodiments, switches or other operating possibilities and the like described above for the one embodiment may also be applicable for one of the other embodiments. Apart from the described applications using the double-sided hydromotors, the invention may be applied unconditionally in situations involving hydraulic cylinders with single-sided load.

How the controls described are to be realized, will be left aside for the moment. It is possible to use electromechanical controls, wherein sensors with respect to, for instance measuring a liquid flow, a number of revolutions, a movement or a pressure, electronically pass on the measured values to an electronic control, subsequent to which, for instance, the hydraulic transformer is adjusted by means of a stepping motor, a servomotor or a hydraulic servo-drive system. It is, however, also conceivable that a complete or partial hydraulic drive system is used, wherein, for instance, valves can be directly activated by a pressure or a pressure ratio.

The different FIGS. 4-8 show how the drive system represented in FIG. 1 reacts to an incremental loading of +65% on torque M at a point in time t=0.2 sec and an incremental loading back to the original moment M at the point in time t=0.6 sec. The fact that the hydraulic transformer is able to react quickly to the altered load conditions has been taken into account by executing the adjustment drive system of the hydraulic transformer such that in a drive system in which the speed of the motor is regulated by means of a control circuit, the band width of the adjusted drive system is approximately 7 Hz. Such a band width is practicable if the adjustment drive system is of the heavy kind, or if the hydraulic transformer to be adjusted is executed in accordance with the hydraulic transformer described in the application PCT/NL97/00084 by the same applicant, which document is to be considered part of this document.

FIG. 4 shows the curve of pressure pB when the hydromotor 10 is connected, and which curve is especially the result of the load M and the adjustment of the hydraulic transformer 11.

FIG. 5 shows the curve of the oil flow QB from the hydraulic transformer 11 to the hydromotor 10, from which can be seen that due to the load the revolutions of the hydromotor drop (QB is lower).

FIG. 6 shows the curve of the oil flow QA from the high-pressure conduit 1 to the hydraulic transformer 11.

FIG. 7 shows a control signal 6, representing the adjustment of the hydraulic transformer 10, triggered by the transformer control 7A.

FIG. 8 shows the pressure pA in the high-pressure accumulator 2. It can be seen that the free-piston aggregate starts when the pressure drops below the predetermined level of 30 MPa, and that after a delay of 22 msec the supply of oil commences and lasts 11 msec, the delay is caused by the free piston first having to carry out a compression stroke, subsequent to which energy developing at combustion, is during the expansion stroke given off to the hydraulic drive system. Because the waiting times between the starting moments vary, the adaptation to the different supplies is realized. It has also been clearly shown that when a small pressure accumulator is employed, there is very little pressure fluctuation and that by means of pulse modulation it is possible to quickly react to the changing energy demand.

1. A hydraulic drive system comprising a pressure conduit (1) connected with several users, a pump (15;17;22) which, after being activated, has a substantially constant delivery for a supply of liquid, for instance oil, to the pressure conduit (1) which is under pressure, a first pressure accumulator (2) coupled with the pressure conduit (1), wherein the active volume of the first pressure accumulator (2) is of a size such that after the pump (15;17;22) is activated and immediately inactivated, the supply of liquid to the first pressure accumulator (2) causes the pressure in the pressure conduit (1) to rise less than maximally allowed for a pulsatory pressure rise, a pressure sensor (5) for measuring the pressure (pA) in the pressure conduit (1), and control means (6) provided with switch means (4;18;24) for activating and inactivating the pump (15;17;22) and/or the pump's (15;17;22) supply of liquid to the pressure conduit (1), characterized in that the control means (6) are connected with the pressure sensor (5) for the adjustment to a substantially constant pressure (pA) in the pressure conduit (1), and in that each of the most important users is connected with the pressure conduit (1) via a hydraulic transformer (9,11) for transforming the pressure (pA) in the pressure conduit (1) into a user's pressure (pB).

2. A hydraulic drive system in accordance with claim 1, in which the pump is a free-piston aggregate (15) comprising a freely movable piston, a hydraulic drive system (3) for controlling the movement of the free piston and a pump cylinder in which a pump piston connected with the pump cylinder can move, and wherein the switch means (4) form a part of the hydraulic drive system (3).

3. A hydraulic drive system in accordance with claim 1, comprising a pump (17) driven by a motor (16), a valve (18) operated by the control means (6), for the communication between the suction side and the delivery side of the pump (17) and a non-return valve (19) provided in the connection with the pressure conduit (1).

4. A hydraulic drive system in accordance with claim 1, comprising a pump (22) driven by a motor (21), and a non-return valve (19) provided in the connection with the pressure conduit (1), and switch means (24) for activating and inactivating the motor (21).

5. A hydraulic drive system in accordance with claim 4, wherein by rotating in opposite directions pump (22) and motor (21) are capable of converting hydraulic energy into electrical energy, and means (25) are present for connecting the pressure conduit (1) with the pump (22) parallel to the non-return valve (19).

6. A hydraulic drive system in accordance with one of the preceding claims, wherein the controls (7A) of the hydraulic transformers (9,11) are connected with a power regulator (7) for regulating the power to be supplied by the hydraulic transformers (9,11).

7. A hydraulic drive system according to claim 6, wherein the power regulator (7) is provided with means for selectively allocating power to certain users.

8. A hydraulic drive system according to claim 7, wherein each pump (15;17;22) is provided with a first pressure accumulator (2).

9. A hydraulic drive system according to one of the preceding claims, wherein the first, preferably small pressure accumulator (2) is coupled to the pressure conduit (1) near the pump (15;17;22), and at some distance thereto at least one second pressure accumulator (26, . . . ) is coupled to the pressure conduit (1), and wherein the gas sides of the first and second pressure accumulators (2,26, . . . ) are connected to a gas pipe (27).
